(19) United States
(12) Patent Application Publication
(10) Pub. No.: US 2010/0141564 A1
(43) Pub. Date: Jun. 10, 2010

(54) Pixel and organic light emitting display device using the same

(76) Inventors: Sang-Moo Choi, Yongin-City (KR); Won-Jun Song, Yongin-City (KR)

Correspondence Address: LEE & MORSE, P.C., 3141 FAIRVIEW PARK DRIVE, SUITE 500, FALLS CHURCH, VA, 22042, US

(21) Appl. No.: 12/591,237

(22) Filed: Nov. 13, 2009

(30) Foreign Application Priority Data
Dec. 5, 2008 (KR) 10-2008-0123140

(51) Int. Cl. G09G 3/30

(52) U.S. Cl. 345/76

(57) ABSTRACT

A pixel includes an organic light emitting diode, a second transistor configured to control a connection between a first power source and the organic light emitting diode, the second transistor having a gate electrode, a first transistor configured to control a connection between the gate electrode of the second transistor and a data line, the first transistor having a gate electrode coupled to a scan line, a third transistor configured to control a connection between the organic light emitting diode and a second electrode of the second transistor, the third transistor having a gate electrode coupled to a light emitting control line, a first capacitor having a first electrode coupled to the gate electrode of the second transistor and having a second electrode coupled to a first electrode of the second transistor, and a second capacitor having a first electrode coupled to the gate electrode of the second transistor.

### BACKGROUND

1. Field

Embodiments relate to a pixel and an organic light emitting display device using the same.

2. Description of the Related Art

Recently, various flat panel display devices having reduced weight and volume, as compared to a cathode ray tube, have been developed. Such flat panel display devices include, e.g., a field emission display device, a plasma display device, an organic light emitting display device, etc.

An organic light emitting display device displays images by using an organic light emitting diode (OLED) generating light through recombination of electrons and holes. Such an organic light emitting diode may offer low power consumption and may have a rapid response speed.

However, the conventional organic light emitting display device may have a problem in that images having a desired brightness may not be displayed due to an efficiency change in the organic light emitting diode resulting from deterioration thereof. As the organic light emitting diode deteriorates with the passage of time, images may not be displayed at a desired brightness level.

### SUMMARY

Embodiments are directed to a pixel and an organic light emitting display device using the same, which substantially overcome one or more problems due to the limitations and disadvantages of the related art.

It is therefore a feature of an embodiment to provide a pixel and an organic light emitting display device using the same which may compensate for deterioration of an organic light emitting diode.

At least one of the above and other features and advantages may be realized by providing a pixel, including an organic light emitting diode, a second transistor configured to control a connection between a first power source and the organic light emitting diode, the second transistor having a gate electrode and controlling an amount of current supplied from the first power source to the organic light emitting diode in correspondence with a voltage at the gate electrode, a first transistor configured to control a connection between the gate electrode of the second transistor and a data line, the first transistor having a gate electrode coupled to a scan line, a third transistor configured to control a connection between the organic light emitting diode and a second electrode of the second transistor, the third transistor having a gate electrode coupled to a light emitting control line, a first capacitor having a first electrode coupled to the gate electrode of the second transistor and having a second electrode coupled to a first electrode of the second transistor, and a second capacitor having a first electrode coupled to the gate electrode of the second transistor, the second capacitor controlling a voltage of the gate electrode of the second transistor in correspondence with a voltage variation of the organic light emitting diode.

The first transistor may be turned on when a scan signal is supplied to the gate electrode thereof, the third transistor may be turned off when the first transistor is turned on, and the third transistor may be turned off when a light emitting control signal is supplied to the gate electrode thereof.

The organic light emitting diode may be configured to decrease in resistance when it deteriorates.

The second capacitor may have a second electrode coupled to a node between the second electrode of the second transistor and a first electrode of the third transistor.

The pixel may further include a fourth transistor configured to control a connection between the first electrode of the second transistor and the second electrode of the second transistor, the fourth transistor having a gate electrode coupled to the scan line.

The fourth transistor may be turned on when a scan signal is supplied to the gate electrode thereof.

The second capacitor may have a second electrode coupled to a node between the second electrode of the third transistor and an electrode of the organic light emitting diode.

At least one of the above and other features and advantages may also be realized by providing an organic light emitting display device, including a scan driver sequentially supplying scan signals to scan lines so that transistors receiving the scan signals are turned on when the scan signals are supplied, and sequentially supplying light emitting control signals to light emitting control lines so that transistors receiving the light emitting control signals are turned off when the light emitting control signals are supplied, a data driver supplying data signals to the data lines when the scan signals are supplied, and pixels coupled to respective scan lines and data lines. The pixels may each include an organic light emitting diode, a second transistor configured to control a connection between a first power source and the organic light emitting diode, the second transistor having a gate electrode and controlling an amount of current supplied from the first power source to the organic light emitting diode in correspondence with a voltage at the gate electrode, a first transistor configured to control a connection between the gate electrode of the second transistor and a data line, the first transistor having a gate electrode coupled to a scan line, a third transistor configured to control a connection between the organic light emitting diode and a second electrode of the second transistor, the third transistor having a gate electrode coupled to a light emitting control line, a first capacitor having a first electrode coupled to the gate electrode of the second transistor and having a second electrode coupled to a first electrode of the second transistor, and a second capacitor having a first electrode coupled to the gate electrode of the second transistor, the second capacitor controlling a voltage of the gate electrode of the second transistor in correspondence with a voltage variation of the organic light emitting diode.

The scan driver may supply a light emitting control signal to an i^{th} light emitting control line (i is a natural number) so that it overlaps with a scan signal supplied to an corresponding i^{th} scan line, the first transistor may be turned on when the scan signal is supplied to the gate electrode thereof, the third transistor may be turned off when the first transistor is turned on, and the third transistor may be turned off when the light emitting control signal is supplied to the gate electrode thereof.

The organic light emitting diode may be configured to decrease in resistance when it deteriorates.

The second capacitor may have a second electrode coupled to a node between the second electrode of the second transistor and a first electrode of the third transistor.

The organic light emitting display device may further include a fourth transistor configured to control a connection between the first electrode of the second transistor and the second electrode of the second transistor, the fourth transistor having a gate electrode coupled to the scan line.

The fourth transistor may be turned on when the scan signal is supplied to the gate electrode thereof.

The second capacitor may have a second electrode coupled to a node between a second electrode of the third transistor and an electrode of the organic light emitting diode.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates an organic light emitting display device according to an embodiment;

FIGS. 2A and 2B illustrate voltage changes corresponding to the deterioration of an organic light emitting diode;

FIG. 3 illustrates a first embodiment of a pixel of FIG. 1;

FIG. 4 illustrates a waveform driving the pixel of FIG. 3;

FIG. 5 illustrates a second embodiment of a pixel of FIG. 1; and

FIG. 6 illustrates a third embodiment of a pixel of FIG. 1.

### DETAILED DESCRIPTION OF PREFERRED EMBODIMENTS

Korean Patent Application No. 10-2008-0123140, filed on Dec. 5, 2008, in the Korean Intellectual Property Office, and entitled: “Pixel and Organic Light Emitting Display Device Using the Same” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. In the drawings, the dimensions of regions may be exaggerated for clarity of illustration. Like reference numerals refer to like elements throughout.

Herein, when a first element is described as being coupled to a second element, the first element may be directly coupled to the second element, or may be indirectly coupled to the second element via a third element. In the drawings, details of elements that are not essential to the complete understanding of the invention may be omitted for clarity.

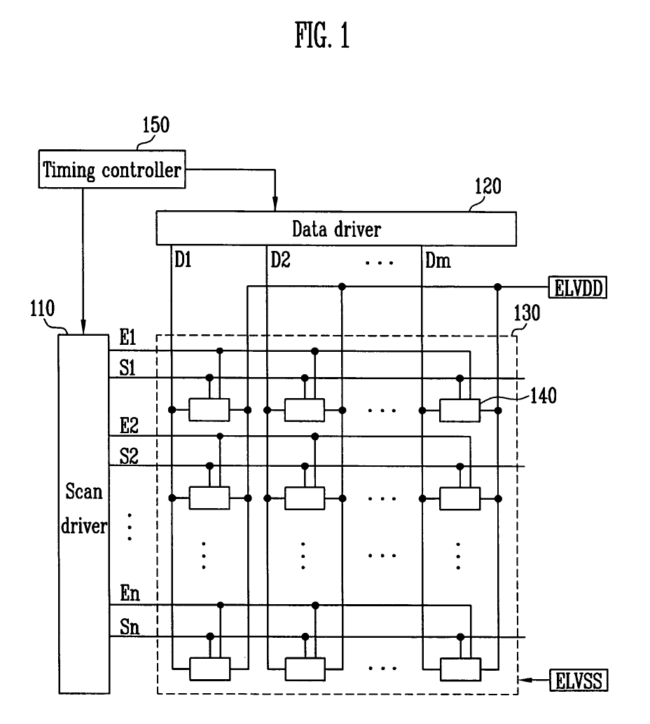

FIG. 1 illustrates an organic light emitting display device according to an embodiment.

Referring to FIG. 1, the organic light emitting display may include a pixel unit 130 including a plurality of pixels 140 positioned in the intersections of scan lines S1 to Sn and data lines D1 to Dm, a scan driver 110 driving the scan lines S1 to Sn and light emitting control lines E1 to En, a data driver 120 driving the data lines D1 to Dm, and a timing controller 150 controlling the scan driver 110 and the data driver 120.

The scan driver 110 may generate scan signals under the control of the timing controller 150 and supply the generated scan signals sequentially to the scan lines S1 to Sn. The scan driver 110 may generate light emitting control signals and supply the generated light emitting control signals sequentially to the light emitting control lines E1 to En. The light emitting control signal supplied to an i^{th} light emitting control line (i is a natural number) may overlap with the scan signal supplied to an i^{th} scan line Si. When supplied, the scan signal is set as voltage at which the controlled transistor can be turned on (for example, low polarity). When supplied, the light emitting control signal is set as voltage at which the controlled transistor can be turned off (for example, high polarity).

The data driver 120 generates the data signals under the control of the timing controller 150, and supplies the generated data signals to the data lines D1 to Dm in order to be synchronized with the scan signals.

The timing controller 150 controls the scan driver 110 and the data driver 120. Also, the timing controller 150 transfers the data supplied from an external source to the data driver 120.

The pixel unit 130 receives first power source ELVDD and second power source ELVSS from outside to supply them to the respective pixels 140. The pixels 140 receiving the first power source ELVDD and the second power source ELVSS generate light corresponding to the respective data signals.

The pixels 140 may compensate for the deterioration of the organic light emitting diode included in each of them to generate light having a desired brightness. More specifically, as the organic light emitting diode deteriorates, the light emitting efficiency is lowered, thereby generating less-bright light. Therefore, the respective pixels 140 increase the amount of current supplied to the organic light emitting diode in an amount corresponding to the deterioration of the organic light emitting diode, thereby compensating for the deterioration of the organic light emitting diode.

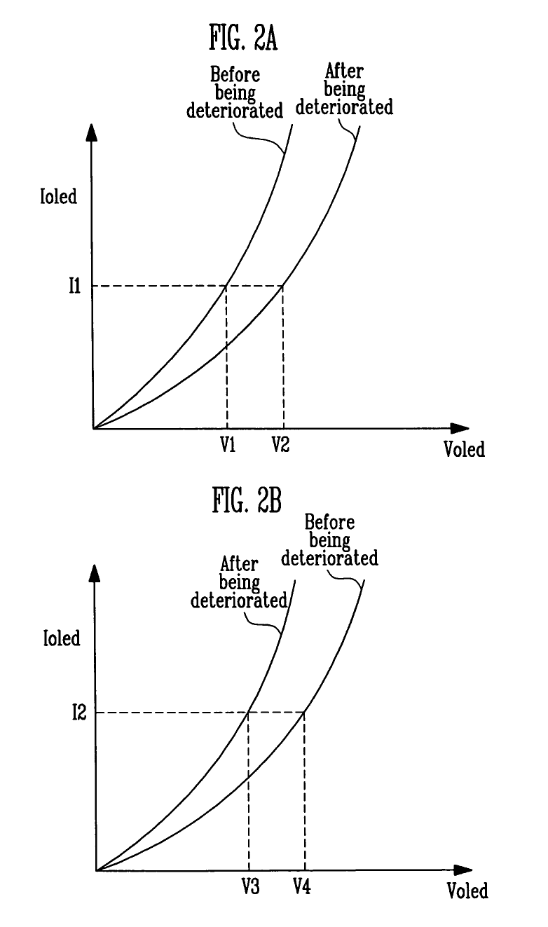

Referring to FIG. 2A, a first type of organic light emitting diode may have a characteristic such that degradation of the organic light emitting diode causes an increase in resistance of the organic light emitting diode. Thus, referring to FIG. 2A, a voltage Voled applied to the organic light emitting device may need to be increased, e.g., from V1 to V2, to provide a same current level I1. In further detail, before degradation of the organic light emitting diode, a first voltage V1 applied to the organic light emitting diode may produce a current flowing through the organic light emitting diode at the level I1. However, after degradation of the organic light emitting diode has begun, a second voltage V2 higher than the first voltage V1 may need to be applied to the organic light emitting diode in order to achieve the same current I1 flowing through the organic light emitting diode.

In contrast, in a second type of organic light emitting diode, the resistance of the organic light emitting diode may be reduced as the organic light emitting diode deteriorates, as shown in FIG. 2B. In particular, as described in detail below, a resistance change may be generated by a chemical reaction, such that a hole injection barrier is reduced and the resistance of the organic light emitting diode is reduced. Therefore, as shown in FIG. 2B, a fourth voltage V4 applied to the organic light emitting diode before deterioration thereof may produce a corresponding current I2, whereas a third voltage V3 lower than the fourth voltage V4 applied after deterioration may produce the same current I2.

In further detail, if the current is applied to the organic light emitting diode, efficiency reduction may result due to deterioration in the interface of electrode/organic material and the deterioration in the organic layer. Thus, although an electron and a hole have the same amount of current (a neutral state) in a device when constant current is supplied, mobile net current actually flowing may change because of the change in mobility due to trapped charge and space-charge-limited current. Owing to the difference of the mobile net current, the ratio of holes:electrons in the light emitting layer is changed and, thus, exciton efficiency is also changed. In the first type of organic light emitting diode, the diode structure may be optimized for an early state, i.e., when the organic light emitting diode is new. As such, the brightness may be lowered with even a small change in net current ratio.

The second type of organic light emitting diode, which may be used the pixel 140, may have the following structure. The basic structure is made of a positive electrode/a hole injection layer/a hole transfer layer/a light emitting layer/an electron transfer layer/an electron injection layer/a negative electrode. The material used as the electron transfer layer may have a net current mobility of, e.g., 10⁻⁵ cm²/VS or more and a thickness of 200 Å to 300 Å. The hole injection layer may be formed of a thin film layer including oxide and having a thickness of 50 Å to 300 Å. For other layers, general materials may be used. Such a structure may have more mobile net current of the electron as compared to the hole in the early state. As the current is driven, a resistance change may be generated in the hole injection layer and the electrode interface relative to the electron transfer layer, and a chemical reaction may be generated in the oxide by means of joule heating at the electrode interface. In this case, the hole injection barrier is reduced and the distribution of the density of sate in the hole injection layer is may be so that the mobile net current may be increased as time elapses. Thus, the resistance of the organic light emitting diode may be reduced as the organic light emitting diode deteriorates.

FIG. 3 illustrates a first embodiment of a pixel of FIG. 1. For convenience of explanation, FIG. 3 illustrates a pixel coupled to an n^{th} scan line Sn and an m^{th} data line Dm.

Referring to FIG. 3, the pixel 140 according to the first embodiment includes an organic light emitting diode OLED and a pixel circuit 142 supplying current to the organic light emitting diode OLED.

An anode electrode of the organic light emitting diode OLED may be coupled to the pixel circuit 142, and a cathode electrode of the organic light emitting diode OLED may be coupled to a second power source ELVSS. The organic light emitting diode OLED may generate light having a predetermined brightness in correspondence with the current supplied from the pixel circuit 142. The first power source ELVDD may have a higher voltage value than the second power source ELVSS.

The pixel circuit 142 may supply an amount of current corresponding to the data signal to the organic light emitting diode OLED. The pixel circuit 142 may control the amount of current so that the deterioration of the organic light emitting diode OLED can be compensated. The pixel circuit 142 may include first to third transistors M1 to M3, a first capacitor C1, and a second capacitor C2. In an implementation, the first to third transistors M1 to M3 may each be PMOS transistors.

A gate electrode of the first transistor M1 may be coupled to the scan line Sn, and a first electrode of the first transistor M1 may be coupled to the data line Dm. A second electrode of the first transistor M1 may be coupled to a gate electrode of the second transistor M2 and to a first node N1. When the scan signal is supplied to the scan line Sn, e.g., when the voltage on the scan line Sn goes low, the first transistor M1 may be turned on to supply the data signal from the data line Dm to the first node N1.

The gate electrode of the second transistor M2 may be coupled to the first node N1, and a first electrode of the second transistor M2 may be coupled to the first power source ELVDD. A second electrode of the second transistor M2 may be coupled to a first electrode of the third transistor M3 and a second node N2. The second transistor M2 may supply an amount of current, corresponding to voltage applied to the first node N1, to the second node N2.

A gate electrode of the third transistor M3 may be coupled to a light emitting control line En, and a first electrode of the third transistor M3 may be coupled to the second node N2. A second electrode of the third transistor M3 may be coupled to the anode electrode of the organic light emitting diode OLED. When the light emitting control signal is not supplied, e.g., when the voltage on the light emitting control line En is low, the third transistor M3 may be turned on to electrically connect the second node N2 to the organic light emitting diode OLED. The third transistor M3 may be set to be turned off when the first transistor M1 is turned on. For example, the first transistor M1 and the third transistor M3 may each be PMOS transistors, and the scan signal may be low when the light emitting control signal is high.

The first capacitor C1 may be coupled between the first node N1 and the first power source ELVDD. The first capacitor C1 may be charged with a predetermined voltage corresponding to the data signal.

The second capacitor C2 may be coupled between the first node N1 and the second node N2. The second capacitor C2 may control the voltage of the first node N1 by corresponding to the voltage variation of the second node N2.

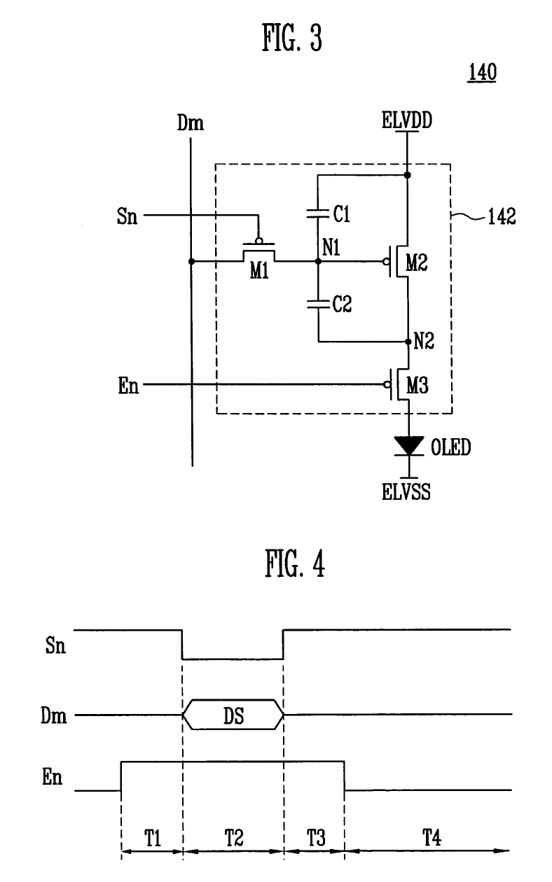

FIG. 4 illustrates a waveform driving the pixel of FIG. 3.

In an example operation of the pixel 140 of FIG. 3, first, the light emitting control signal may be supplied to the light emitting control line En, e.g., so that the light emitting control line En goes high, during a first period T1 so that the third transistor M3 is turned off. If the third transistor M3 is turned off, the second node N2 is electrically isolated from the organic light emitting diode OLED.

Thereafter, the second signal may be supplied to the scan line Sn during a second period T2 so that the first transistor M1 is turned on. If the first transistor M1 is turned on, the data signal DS is supplied from the data line Dm to the first node N1. At this time, the voltage corresponding to the data signal DS on the data line Dm is applied to the first node N1.

The voltage of the data signal DS may be set as a voltage that can turn on the second transistor M2. Therefore, as the net current is charged through the second transistor M2, the voltage of the second node N2 rises to the voltage of the first power source ELVDD.

The supply of the scan signal to the scan line Sn may be suspended, e.g., the scan line Sn goes high, during a third period T3 so that the first transistor M1 is turned off. At this time, the second transistor M2 is set in a turned-off state, and the first node N1 and the second node N2 maintain the voltage of the second period T2.

The supply of the light emitting control signal to the light emitting control line En may be suspended, e.g., the light emitting control line En goes low, during a fourth period T4 so that the third transistor M3 is turned on. If the third transistor M3 is turned on, the current corresponding to the voltage applied to the first node N1 is supplied to the organic light emitting diode OLED. At this time, the voltage Voled corresponding to the current is applied to the organic light emitting diode OLED.

In the above-described operation, the voltage variation of the second node N2 is set as shown in Equation 1 below.

ΔN2=ELVDD−Voled [Equation 1]

When the voltage of the second node N2 is changed as shown in Equation 1, the voltage variation of the first node N1 is set as shown Equation 2 below, by a coupling phenomenon of the second capacitor C2.

ΔN1={C2/(C1+C2)}×(ELVDD−Voled) [Equation 2]

The voltage of the first power source ELVDD may be set to be larger than the voltage Voled applied to the organic light emitting diode OLED so that the voltage of the first node N1 is reduced by the voltage of ΔN1.

When the organic light emitting diode OLED deteriorates, the voltage Voled applied to the organic light emitting diode OLED may be reduced. Therefore, the voltage of ΔN1 may increase as the organic light emitting diode OLED deteriorates. Thus, as the organic light emitting diode OLED deteriorates, the voltage of the first node N1 may becomes lower and thus, the amount of current supplied to the organic light emitting diode OLED may be increased.

As described above, the amount of current supplied to the organic light emitting diode OLED may be increased corresponding to the efficiency reduction from the deterioration of the organic light emitting diode OLED, making it possible to compensate for the brightness lowering from the deterioration of the organic light emitting diode OLED.

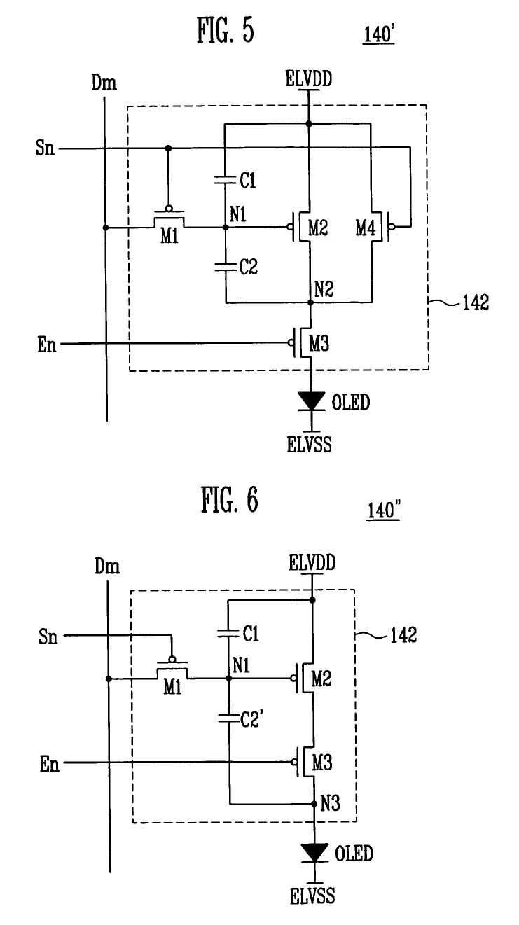

FIG. 5 illustrates a second embodiment of a pixel of FIG. 1. In connection with the description of FIG. 5, the same reference numerals will be given to the same description as for FIG. 3 and the detailed description thereof will not be repeated.

Referring to FIG. 5, the pixel 140′ according to the second embodiment may further include a fourth transistor M4 between the first power source ELVDD and the second node N2. When the scan signal is supplied to the scan line Sn, e.g., when the scan line Sn goes low, the fourth transistor M4 may be turned on to supply the voltage of the first power source ELVDD to the second node N2. Other operation processes may be the same as those described above in connection with FIG. 3 and thus the detailed description thereof will be omitted.

FIG. 6 illustrates a third embodiment of a pixel of FIG. 1. In connection with the description of FIG. 6, the same reference numerals will be given to the same description as for FIG. 3 and the detailed description thereof will not be repeated.

Referring to FIG. 6, in the pixel 140″ according to the third embodiment, a second capacitor C2′ may be coupled between the first node N1 and the anode electrode of the organic light emitting diode OLED. The components other than the second capacitor C2′ may be the same as those in FIG. 3.

Describing the operation process of the pixel 140″ of FIG. 6 with reference to FIGS. 4 and 6, first, the light emitting control signal maybe supplied to the light emitting control line En, e.g., the light emitting control line En may go high, during a first period T1 so that the third transistor M3 is turned off. If the third transistor M3 is turned off, the second node N2 is electrically blocked from the organic light emitting diode OLED. In this case, the voltage of the third node N3 may be set as an off-state voltage of the organic light emitting diode OLED.

Thereafter, the second signal may be supplied to the scan line Sn, e.g., the scan line Sn may go low, during a second period T2 so that the first transistor M1 is turned on. If the first transistor M1 is turned on, the data signal is supplied from the data line Dm to the first node N1.

The supply of the scan signal to the scan line Sn may be suspended, e.g., the scan line Sn may go high, during a third period T3 so that the first transistor M1 is turned off. At this time, the second transistor M2 may be in a turned-off state, and the first node N1 and the second node N2 may maintain the voltage of the second period T2.

The supply of the light emitting control signal to the light emitting control line En may be suspended, e.g., the light emitting control line may go low, during a fourth period so that the third transistor M3 is turned on. If the third transistor M3 is turned on, the current corresponding to the voltage applied to the first node N1 is supplied to the organic light emitting diode OLED. At this time, the voltage Voled corresponding to the current is applied to the organic light emitting diode OLED.

In this case, the voltage of the third node N3 rises from the off-voltage of the organic light emitting diode OLED to the voltage Voled applied to the organic light emitting diode OLED, corresponding to the current. At this time, the voltage of the first node N1 also rises in correspondence with the rising voltage of the third node N3.

Meanwhile, the voltage Voled applied to the organic light emitting diode OLED may become low as the organic light emitting diode deteriorates. Therefore, as the organic light emitting diode OLED deteriorates, the voltage rising of the first node N1 may becomes low and, thus, the amount of current flowing onto the organic light emitting diode OLED from the second transistor M2 may be increased.

In the pixel 140″ according to the third embodiment, as the organic light emitting diode OLED deteriorates, the rising voltage of the first node N1 may be lowered, thereby making it possible to increase the amount of current supplied to the organic light emitting diode OLED. In this case, the decrease of exciton efficiency can be compensated against the deterioration of the organic light emitting diode OLED.

As described above, as an organic light emitting diode deteriorates, the pixel and the organic light emitting diode display using the same according to embodiments may increase the amount of the current supplied to the organic light emitting diode, making it possible to compensate for the deterioration of the organic light emitting diode. Thus, according to embodiments, images having a desired brightness may be displayed even if the organic light emitting diode begins to deteriorate.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A pixel, comprising:
an organic light emitting diode;
a second transistor configured to control a connection between a first power source and the organic light emitting diode, the second transistor having a gate electrode and controlling an amount of current supplied from the first power source to the organic light emitting diode in correspondence with a voltage at the gate electrode;
a first transistor configured to control a connection between the gate electrode of the second transistor and a data line, the first transistor having a gate electrode coupled to a scan line;
a third transistor configured to control a connection between the organic light emitting diode and a second electrode of the second transistor, the third transistor having a gate electrode coupled to a light emitting control line;
a first capacitor having a first electrode coupled to the gate electrode of the second transistor and having a second electrode coupled to a first electrode of the second transistor; and
a second capacitor having a first electrode coupled to the gate electrode of the second transistor, the second capacitor controlling a voltage of the gate electrode of the second transistor in correspondence with a voltage variation of the organic light emitting diode.

2. The pixel as claimed in claim 1, wherein:
the first transistor is turned on when a scan signal is supplied to the gate electrode thereof,
the third transistor is turned off when the first transistor is turned on, and
the third transistor is turned off when a light emitting control signal is supplied to the gate electrode thereof.

3. The pixel as claimed in claim 1, wherein the organic light emitting diode is configured to decrease in resistance when it deteriorates.

4. The pixel as claimed in claim 1, wherein the second capacitor has a second electrode coupled to a node between the second electrode of the second transistor and a first electrode of the third transistor.

5. The pixel as claimed in claim 4, further comprising a fourth transistor configured to control a connection between the first electrode of the second transistor and the second electrode of the second transistor, the fourth transistor having a gate electrode coupled to the scan line.

6. The pixel as claimed in claim 5, wherein the fourth transistor is turned on when a scan signal is supplied to the gate electrode thereof.

7. The pixel as claimed in claim 1, wherein the second capacitor has a second electrode coupled to a node between the second electrode of the third transistor and an electrode of the organic light emitting diode.

8. An organic light emitting display device, comprising:
a scan driver sequentially supplying scan signals to scan lines so that transistors receiving the scan signals are turned on when the scan signals are supplied, and sequentially supplying light emitting control signals to light emitting control lines so that transistors receiving the light emitting control signals are turned off when the light emitting control signals are supplied;
a data driver supplying data signals to the data lines when the scan signals are supplied; and
pixels coupled to respective scan lines and data lines, wherein the pixels each include:
an organic light emitting diode;
a second transistor configured to control a connection between a first power source and the organic light emitting diode, the second transistor having a gate electrode and controlling an amount of current supplied from the first power source to the organic light emitting diode in correspondence with a voltage at the gate electrode;
a first transistor configured to control a connection between the gate electrode of the second transistor and a data line, the first transistor having a gate electrode coupled to a scan line;
a third transistor configured to control a connection between the organic light emitting diode and a second electrode of the second transistor, the third transistor having a gate electrode coupled to a light emitting control line;
a first capacitor having a first electrode coupled to the gate electrode of the second transistor and having a second electrode coupled to a first electrode of the second transistor; and
a second capacitor having a first electrode coupled to the gate electrode of the second transistor, the second capacitor controlling a voltage of the gate electrode of the second transistor in correspondence with a voltage variation of the organic light emitting diode.

9. The organic light emitting display device as claimed in claim 8, wherein:
the scan driver supplies a light emitting control signal to an i^{th} light emitting control line (i is a natural number) so that it overlaps with a scan signal supplied to an corresponding i^{th} scan line,
the first transistor is turned on when the scan signal is supplied to the gate electrode thereof,
the third transistor is turned off when the first transistor is turned on, and
the third transistor is turned off when the light emitting control signal is supplied to the gate electrode thereof.

10. The organic light emitting display device as claimed in claim 8, wherein the organic light emitting diode is configured to decrease in resistance when it deteriorates.

11. The organic light emitting display device as claimed in claim 8, wherein the second capacitor has a second electrode coupled to a node between the second electrode of the second transistor and a first electrode of the third transistor.

12. The organic light emitting display device as claimed in claim 11, further comprising a fourth transistor configured to control a connection between the first electrode of the second transistor and the second electrode of the second transistor, the fourth transistor having a gate electrode coupled to the scan line.

13. The organic light emitting display device as claimed in claim 12, wherein the fourth transistor is turned on when the scan signal is supplied to the gate electrode thereof.

14. The organic light emitting display device as claimed in claim 8, wherein the second capacitor has a second electrode coupled to a node between a second electrode of the third transistor and an electrode of the organic light emitting diode.
